(19) United States
(12) Patent Application Publication
(10) Pub. No.: US 2026/0153226 A1
(43) Pub. Date: Jun. 4, 2026

(54) OUTPUT BEAM SHAPING FOR A LUMINAIRE

(71) Applicant: ROBE lighting s.r.o., Roznov pod Radhostem (CZ)

(72) Inventors: Pavel Jurik, Prostredni Becva (CZ); Jan Vilem, Valasske Mezirici (CZ); Tomas David, Podoli (CZ); Josef Valchar, Prostredni Becva (CZ)

(21) Appl. No.: 19/459,858

(22) Filed: Jan. 26, 2026

(51) Int. Cl. F21V 17/00; F21V 3/04; F21W 131/406

(52) U.S. Cl. CPC F21V 17/002; F21V 3/049; F21W 2131/406

(57) ABSTRACT

A luminaire includes a light source configured to generate an emitted light beam and an interchangeable lens subsystem positioned after the light source and before an imaging plane in an optical path of the luminaire. The interchangeable lens subsystem includes a first lens having a first focal length and a second lens having a second focal length. The second focal length is different than the first focal length. In a first configuration of the interchangeable lens subsystem, the first lens is positioned in the emitted light beam, and in a second configuration of the interchangeable lens subsystem, the second lens is positioned in the emitted light beam.

### CROSS-REFERENCE TO RELATED APPLICATIONS

Not applicable.

### TECHNICAL FIELD OF THE DISCLOSURE

The present disclosure generally relates to automated luminaires, and more specifically to an interchangeable lens subsystem positioned between a light source and an imaging plane of the luminaire.

### BACKGROUND

Luminaires with automated and remotely controllable functionality (referred to as automated luminaires) are known in the entertainment and architectural lighting markets. Such products are commonly used in theatres, television studios, concerts, theme parks, night clubs, and other venues. Many products provide control over parameters such as the intensity, color, focus, beam size, beam shape, and beam pattern and may also provide control over pan and tilt.

### SUMMARY

In a first embodiment, a luminaire includes a light source configured to generate an emitted light beam and an interchangeable lens subsystem positioned after the light source and before an imaging plane in an optical path of the luminaire. The interchangeable lens subsystem includes a first lens having a first focal length and a second lens having a second focal length. The second focal length is different than the first focal length. In a first configuration of the interchangeable lens subsystem, the first lens is positioned in the emitted light beam, and in a second configuration of the interchangeable lens subsystem, the second lens is positioned in the emitted light beam.

In a second embodiment, a luminaire includes a light source configured to generate an emitted light beam and an interchangeable lens-diffuser subsystem positioned after the light source and before an imaging plane in an optical path of the luminaire. The interchangeable lens-diffuser subsystem includes a motorized wheel and an aspherical condenser lens in a first position of the motorized wheel. The interchangeable lens-diffuser subsystem also includes a stacked arrangement of an aspherical condenser lens and a first diffuser in a second position of the motorized wheel, where the first diffuser is configured to provide a first degree of diffusion to a light beam passing therethrough; a stacked arrangement of an aspherical condenser lens and a second diffuser in a third position of the motorized wheel, where the second diffuser is configured to provide a second degree of diffusion to a light beam passing therethrough, and where the second degree is greater than the first degree; a stacked arrangement of a spherical condenser lens and a third diffuser in a fourth position of the motorized wheel, where the third diffuser is configured to provide a third degree of diffusion to a light beam passing therethrough; and a stacked arrangement of a spherical condenser lens and a fourth diffuser in a fifth position of the motorized wheel, where the fourth diffuser is configured to provide a fourth degree of diffusion to a light beam passing therethrough, and where the fourth degree is greater than the third degree.

### BRIEF DESCRIPTION OF THE DRAWINGS

For a more complete understanding of the present disclosure and the advantages thereof, reference is now made to the following description taken in conjunction with the accompanying drawings in which like reference numerals indicate like features and wherein:

FIG. 1 presents an isometric view of a luminaire according to the disclosure;

FIG. 2 presents an isometric view of the head of the luminaire of FIG. 1 with a head cover removed, revealing the internal optical system;

FIGS. 3-8 show the light source housing of FIG. 2 including an interchangeable lens subsystem and an interchangeable diffuser subsystem in greater detail and in varying configurations according to the disclosure;

FIG. 9 shows a simplified front view of the interchangeable lens subsystem and the interchangeable diffuser subsystem according to the disclosure;

FIG. 10 shows a schematic side view of portions of the internal optical system corresponding to the configuration shown in FIG. 9 according to the disclosure;

FIG. 11 shows a simplified front view of the interchangeable lens subsystem and the interchangeable diffuser subsystem according to the disclosure;

FIG. 12 shows a simplified front view of the interchangeable lens subsystem and the interchangeable diffuser subsystem according to the disclosure;

FIG. 13 shows a simplified front view of the interchangeable lens subsystem and the interchangeable diffuser subsystem according to the disclosure;

FIG. 14 shows a schematic side view of portions of the internal optical system corresponding to the configuration shown in FIG. 13 according to the disclosure;

FIG. 15 shows a simplified front view of the interchangeable lens subsystem and the interchangeable diffuser subsystem according to the disclosure;

FIG. 16 shows a simplified front view of the interchangeable lens subsystem and the interchangeable diffuser subsystem according to the disclosure;

FIGS. 17 and 18 show a relationship between the interchangeable lens/diffuser subsystems and gobo wheels in greater detail according to the disclosure; and

FIGS. 19 and 20 present different exploded views of the internal optical system of the luminaire of FIG. 1.

### DETAILED DESCRIPTION

Preferred embodiments are illustrated in the figures, like numerals being used to refer to like and corresponding parts of the various drawings.

Luminaires employ various optical components to control and manipulate light beams for projection applications. These optical components typically include light sources, condenser lenses, imaging planes, and pattern-forming elements such as gobos. Condenser lenses are positioned in the optical path of the luminaire to collect and direct light from the light source toward subsequent optical elements. These lenses may be aspherical or spherical in configuration, with each configuration enabling distinct focal characteristics and beam-forming properties. Diffusion elements may be incorporated into the optical path to modify beam homogeneity and intensity distribution. Gobo wheels containing multiple patterned apertures or gobos enable selective projection of various images and shapes. In some embodiments, in addition to gobos, a gobo wheel also includes an open position to project a light beam that is unmodified by a gobo.

It is becoming common to utilize high-power light-emitting diodes (LEDs) or lasers as the light source in automated luminaires. In such luminaire systems, the light source module is often integrated with heat management components and maintained in a fixed position within a housing of the luminaire. Also, in conventional light source modules, particularly laser-powered systems, the working distance and gobo aperture size are typically fixed. To achieve maximum intensity and narrow beam output, conventional systems may employ relatively small gobo openings. While projection optics in such systems often incorporate zoom mechanisms to vary beam angle, the small gobo aperture constrains the usable zoom range at wider angles. Additionally, configurations optimized for maximum intensity frequently produce a pronounced hotspot in the output beam, resulting in non-uniform illumination.

In older lamp-based systems, one known solution involved physically moving the lamp position and switching to a larger set of gobos. However, this approach is impractical in modern laser-based luminaires because the light source module is mechanically complex and integrated with heat dissipation structures, making physical repositioning of the source difficult or impossible. Further, using small gobo apertures with optical configurations designed for larger apertures may result in substantial light loss, because most of the collected light is blocked by the gobo structure rather than passing through the aperture. This inefficiency is particularly problematic when producing narrow aerial beams using small hole gobos in systems designed for larger aperture illumination.

Embodiments of the present disclosure address the foregoing by providing an interchangeable lens subsystem that enables controllable modification of the optical output of the light source for different use cases (e.g., different gobo sizes and/or desired lighting effects), while maintaining optical efficiency. In particular, a luminaire includes a light source configured to generate an emitted light beam, and an interchangeable lens subsystem positioned after the light source, but before an imaging plane (e.g., a gate), at which a gobo or other image generator is located in an optical path of the luminaire. For example, the interchangeable lens subsystem may be positioned proximate to an exit of the light source from which the light beam is emitted. The interchangeable lens subsystem includes a first lens having a first focal length, and a second lens having a second, different focal length. In one example, the first lens is an aspherical lens and the second lens is a spherical lens. The interchangeable lens subsystem may be in a first configuration, in which the first lens is positioned in the emitted light beam, or in a second configuration, in which the second lens is positioned in the emitted light beam.

In one example, the first lens is an aspherical condenser lens with a relatively shorter focal length, producing a relatively small image for high-intensity output, which may be useful for smaller gobos. In this example, the second lens is a spherical condenser lens with a relatively longer focal length, producing a larger image for wider output, which may be useful for larger gobos. The spherical lens configuration provides the additional benefit of reducing the beam diameter within the focus module, which improves output quality by reducing off-axis rays and producing sharper gobo images. Because the optical output is modified by exchanging lenses at the light source exit where the beam is nearly collimated, rather than by moving the light source itself, the system maintains a relatively high optical efficiency.

Additionally, the luminaire may include an interchangeable diffuser subsystem positioned after the interchangeable lens subsystem and before the imaging plane in the optical path. The interchangeable diffuser subsystem includes a first diffuser configured to provide a first degree of diffusion to a light beam passing therethrough, and a second diffuser configured to provide a second, greater degree of diffusion to a light beam passing therethrough. The interchangeable diffuser subsystem may be in a first, second, or third configuration. In the first configuration, neither diffuser is positioned in the emitted light beam to provide maximum intensity. In the second configuration, the first diffuser is positioned in the emitted light beam to provide a slight improvement in beam homogeneity. In the third configuration, the second diffuser is positioned in the emitted light beam to provide maximum flatness and homogeneity. In one example, the configuration of the interchangeable lens subsystem is controllable independently of the configuration of the interchangeable diffuser subsystem, which allows for any combination of lenses and diffusers to be positioned in the emitted light beam. The embodiments described herein may incorporate control systems with data links to enable remote actuation of various optical components (e.g., the interchangeable lens subsystem, the interchangeable diffuser subsystem), and coordination of various optical elements to achieve desired output characteristics. These and other examples are described in further detail below, with reference made to the accompanying figures.

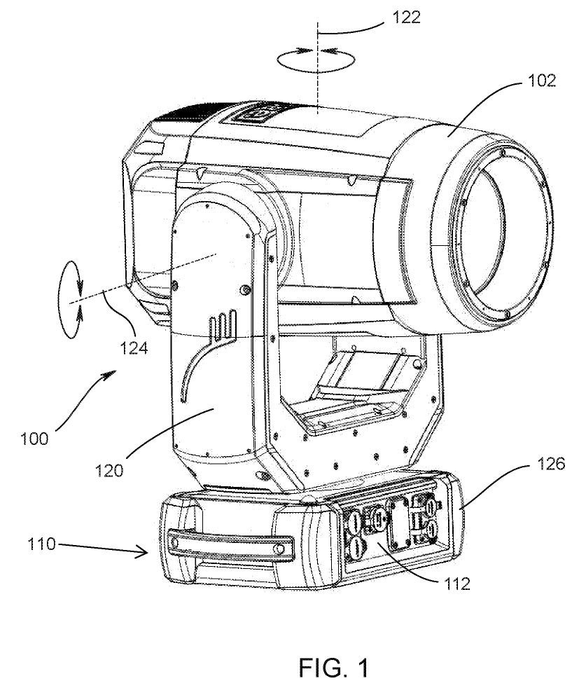

FIG. 1 presents an isometric view of a luminaire 100 according to the disclosure. The luminaire 100 is a luminaire comprising a head 102 which is configured to rotate within a yoke 120 about a tilt axis 124. The yoke 120 is configured to rotate relative to a fixed enclosure 126 (e.g., or a base 126) about a pan axis 122. The pan axis 122 and the tilt axis 124 are orthogonal to each other. Both pan and tilt motions may be mechanically coupled to hand-operated manual controls or may be coupled for motion to motors, linear actuators, or other electromechanically controlled mechanisms. Such electromechanical mechanisms may be under the control of a control system 110 (e.g., a microcontroller or other programmable processing system) included in the luminaire 100. In some embodiments, the control system 110 may be controlled locally via a user interface 112 included in the luminaire 100. The user interface 112 may include a display and/or user input device(s). In other embodiments, the control system 110 may be in wired or wireless communication via a data link with a remotely located control console that an operator uses to indicate a desired position of the head 102. In such embodiments, the operator is able to direct light output from the luminaire 100 in a desired direction, through motion of the head 102 in the pan axis 122 and tilt axis 124.

The luminaire 100 may also include a control system (or controller) 110. The control system 110 is configured to control a motion of the various electromechanical mechanisms of the luminaire 100, such as the interchangeable lens subsystem and/or the interchangeable diffuser subsystem introduced above. In various embodiments, the control system 110 comprises a microcontroller or other programmable processing system. In some embodiments, the control system 110 may be coupled for local control to a user interface 112 included in the luminaire 100 and configured to receive therefrom signals relating to desired positions of the electromechanical mechanisms.

In other embodiments, the control system 110 may be coupled for remote control by the data link (e.g., a wired or wireless data link) to a remotely located control console and to receive signals therefrom (e.g., commands) indicating various electrical or electromechanical control operations to be carried out by the luminaire 100. The data link may use DMX512 (Digital Multiplex) protocol or other suitable communication protocol, e.g., Art-Net, Architecture for Control Networks (ACN), and Streaming ACN.

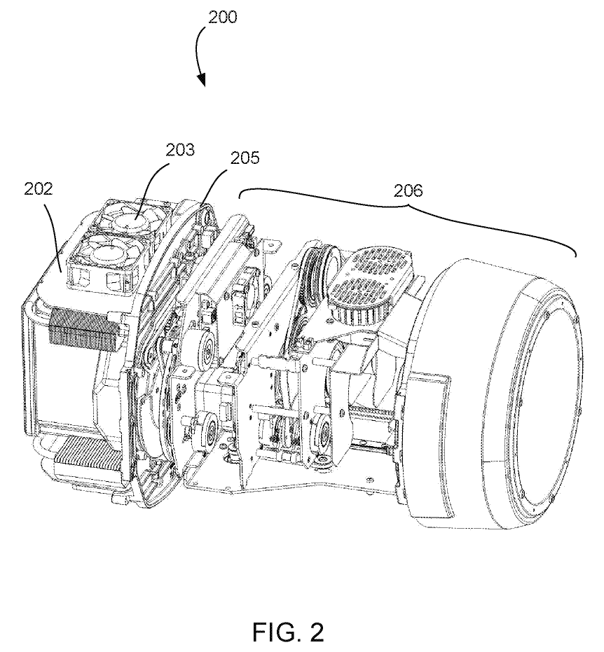

FIG. 2 presents an isometric view of the head 102 of luminaire 100 of FIG. 1 with a head cover removed, revealing an internal optical system 200 according to the disclosure. The internal optical system 200 comprises various optical subsystems including, but not limited to, the optical subsystems described herein. A light beam is produced by a light source 202, which may be a discharge lamp, a light emitting diode (LED) array, a laser based light source, or other light source. The light source 202 may include one or more heatsinks coupled thereto, to facilitate cooling of the light source 202. Cooling fans 203 may be positioned proximate to the light source 202 (and the heatsinks thereof) to provide active airflow around the light source 202 to further facilitate cooling of the light source 202. In FIG. 2, a housing for the light source 202 includes a front face 205, which may be a bulkhead 205 in an example. The front face 205 may be a diecast plate that forms the front of the housing for the light source 202, and also functions as a rear bulkhead 205 of an optical assembly 206 of the luminaire 100. As described further below, the interchangeable lens subsystem (and optionally the interchangeable diffuser subsystem) may be mounted on the front face 205 of the light source 202 housing.

As explained above, it may be useful for the luminaire 100 to generate a light beam having different characteristics for different use cases, while maintaining a relatively high optical efficiency. For example, it may be useful to tailor the generated light beam for different gobos having different aperture sizes, to reduce the visibility of a hotspot in a projected image, and/or to generally produce an output beam with increased flatness and homogeneity.

The below-described embodiments address the foregoing with an interchangeable lens subsystem that is controllable to modify the optical output of the light source 202 for different use cases (e.g., different gobo sizes and/or desired lighting effects), while maintaining optical efficiency. The interchangeable lens subsystem is positioned after the light source 202, but before a gate in an optical path of the luminaire 100, which is farther away from the light source 202 in the optical assembly 206. For example, the interchangeable lens subsystem may be positioned proximate to an exit of the light source 202 from which the light beam is emitted. In particular, the interchangeable lens subsystem may be mounted on the front face 205 of the light source 202 housing.

The interchangeable lens subsystem includes a first lens having a first focal length, and a second lens having a second, different focal length. In other embodiments, the first and second lenses may not be single lenses, but rather one or both lenses could each comprise a stack of lenses in a single housing forming a single optical element. In still other embodiments, one or both lenses could comprise multiple lenslets, or an array of lenslets (e.g., a fly-eye lens array). Regardless of the particular configuration of the first and second lenses, in one example the first lens is an aspherical lens and the second lens is a spherical lens.

The first lens having a relatively shorter focal length produces a relatively small image better-suited for high-intensity output, which may be useful for smaller gobos. The second lens having a relatively longer focal length produces a larger image for wider output, which may be useful for larger gobos. In an example in which the second lens is a spherical lens, the spherical second lens provides the additional benefit of reducing the beam diameter within the focus module (i.e., in the optical assembly 206), which improves output quality by reducing off-axis rays and producing sharper gobo images. The interchangeable lens subsystem enables modifying the optical output by exchanging lenses at the light source 202 exit where the beam is nearly collimated, rather than by moving the light source 202 itself. As a result, the luminaire 100 maintains a relatively high optical efficiency.

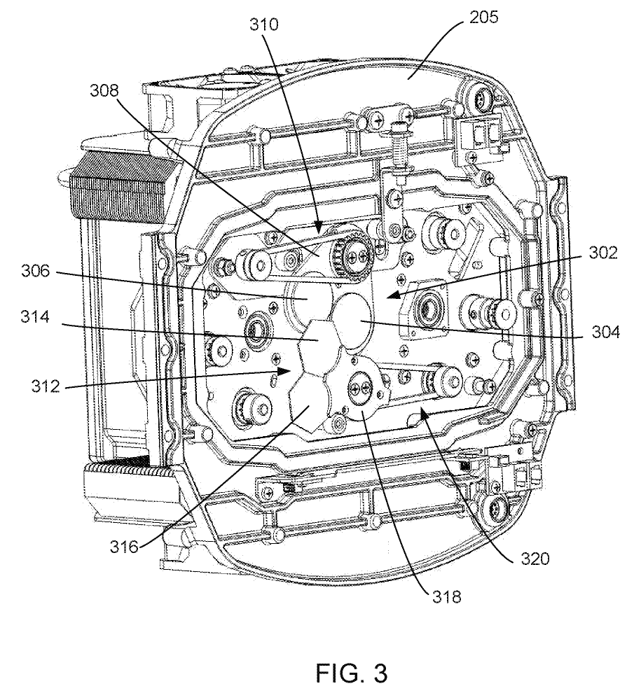

FIG. 3 shows the front face 205 of the light source 202 housing in greater detail. In FIG. 3, an interchangeable lens subsystem 302 includes a first lens 304 and a second lens 306, and is coupled to the front face 205. In this example, the interchangeable lens subsystem 302 is positioned before the imaging plane in the optical path of the luminaire 100. As explained above, the first lens 304 has a first focal length, and the second lens 306 has a second, different focal length.

In FIG. 3, the interchangeable lens subsystem 302 is in a first configuration, in which the first lens 304 is positioned in the emitted light beam (i.e., from light source 202). The interchangeable lens subsystem 302 includes a motorized carrier 308 that holds the first lens 304 and the second lens 306. The motorized carrier 308 may be driven (e.g., to rotate or translate to position one of the first lens 304 and the second lens 306 in the emitted light beam) by any suitable means. In FIG. 3, the motorized carrier 308 is driven by a belt drive assembly 310.

In FIG. 3, an interchangeable diffuser subsystem 312 is also included. The interchangeable diffuser subsystem 312 includes a first diffuser 314 and a second diffuser 316, and is coupled to the front face 205. As shown, the first diffuser 314 and the second diffuser 316 are hexagonal in shape and a side of the first diffuser 314 abuts a side of the second diffuser 316, which may provide a smoother visual transition between degrees of diffusion offered by the first and second diffusers 314, 316. In this example, the interchangeable diffuser subsystem 312 is positioned after the interchangeable lens subsystem 302, but still before the imaging plane in the optical path of the luminaire 100. As explained above, the first diffuser 314 provides a first degree of diffusion to a light beam passing therethrough, and the second diffuser 316 provides a second, greater degree of diffusion to a light beam passing therethrough.

In FIG. 3, the interchangeable diffuser subsystem 312 is in a first configuration, in which neither the first diffuser 314 nor the second diffuser 316 is positioned in the emitted light beam. That is, when the interchangeable lens subsystem 302 is in the first configuration and the interchangeable diffuser subsystem 312 is in the first configuration, the light beam only passes through the first lens 304. The interchangeable diffuser subsystem 312 includes a motorized carrier 318 that holds the first diffuser 314 and the second diffuser 316. The motorized carrier 318 may be driven (e.g., to rotate or translate to position one of the first diffuser 314 and the second diffuser 316 in the emitted light beam) by any suitable means. In FIG. 3, the motorized carrier 318 is driven by a belt drive assembly 320. The configuration of the interchangeable lens subsystem 302 is controllable independently of the configuration of the interchangeable diffuser subsystem 312 because each has their own associated motorized carrier 308, 318 and belt drive assembly 310, 320, respectively.

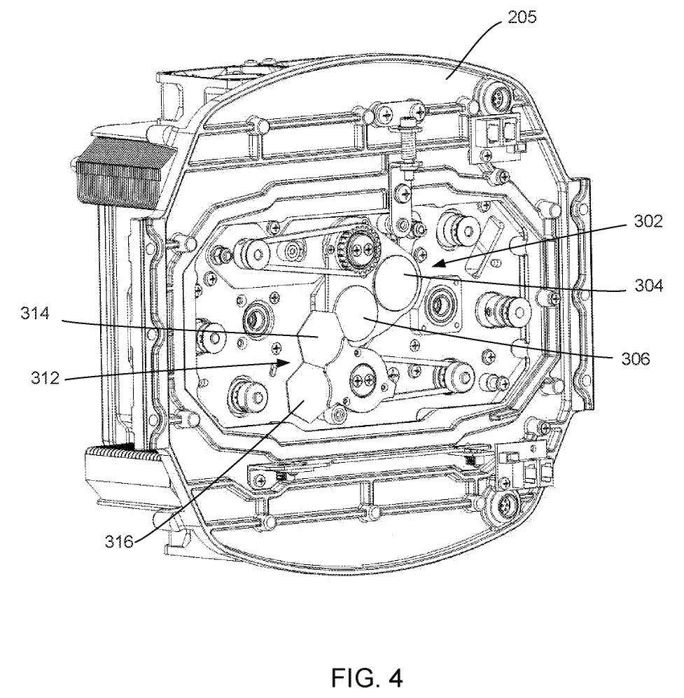

FIG. 4 shows the front face 205 of the light source 202 housing with the interchangeable lens subsystem 302 in a second configuration, in which the second lens 306 is positioned in the emitted light beam (i.e., from light source 202). In FIG. 4, the interchangeable diffuser subsystem 312 is still in the first configuration, in which neither the first diffuser 314 nor the second diffuser 316 is positioned in the emitted light beam. That is, when the interchangeable lens subsystem 302 is in the second configuration and the interchangeable diffuser subsystem 312 is in the first configuration, the light beam only passes through the second lens 306.

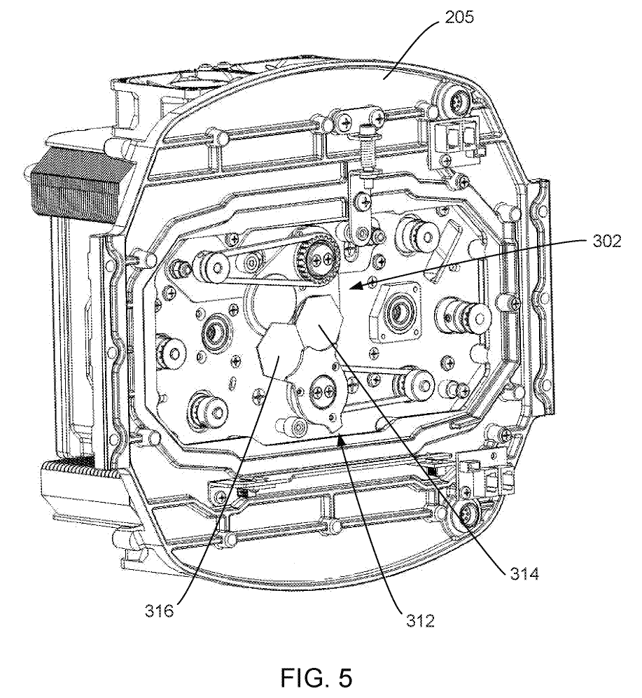

FIG. 5 shows the front face 205 of the light source 202 housing with the interchangeable lens subsystem 302 in the first configuration, in which the first lens (occluded by the first diffuser 314 in FIG. 5) is positioned in the emitted light beam (i.e., from light source 202). In FIG. 5, the interchangeable diffuser subsystem 312 is in a second configuration, in which the first diffuser 314 is positioned in the emitted light beam. That is, when the interchangeable lens subsystem 302 is in the first configuration and the interchangeable diffuser subsystem 312 is in the second configuration, the light beam passes through the first lens 304 and the first diffuser 314.

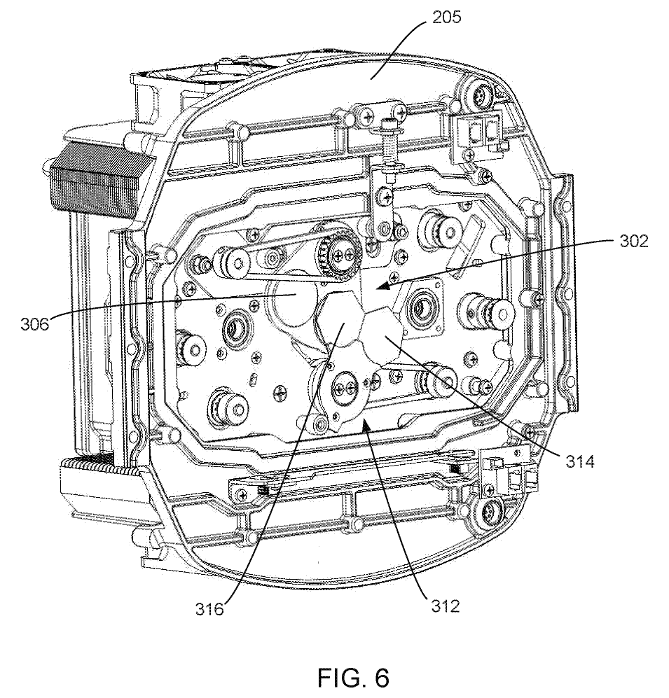

FIG. 6 shows the front face 205 of the light source 202 housing with the interchangeable lens subsystem 302 in the first configuration, in which the first lens (occluded by the second diffuser 316 in FIG. 6) is positioned in the emitted light beam (i.e., from light source 202). In FIG. 6, the interchangeable diffuser subsystem 312 is in a third configuration, in which the second diffuser 316 is positioned in the emitted light beam. That is, when the interchangeable lens subsystem 302 is in the first configuration and the interchangeable diffuser subsystem 312 is in the third configuration, the light beam passes through the first lens 304 and the second diffuser 316.

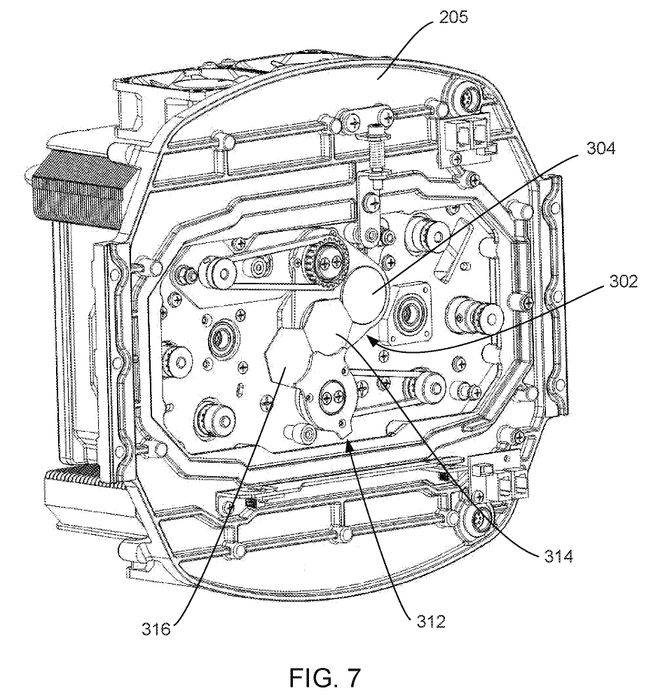

FIG. 7 shows the front face 205 of the light source 202 housing with the interchangeable lens subsystem 302 in the second configuration, in which the second lens (occluded by the first diffuser 314 in FIG. 7) is positioned in the emitted light beam (i.e., from light source 202). In FIG. 7, the interchangeable diffuser subsystem 312 is in the second configuration, in which the first diffuser 314 is positioned in the emitted light beam. That is, when the interchangeable lens subsystem 302 is in the second configuration and the interchangeable diffuser subsystem 312 is in the second configuration, the light beam passes through the second lens 306 and the first diffuser 314.

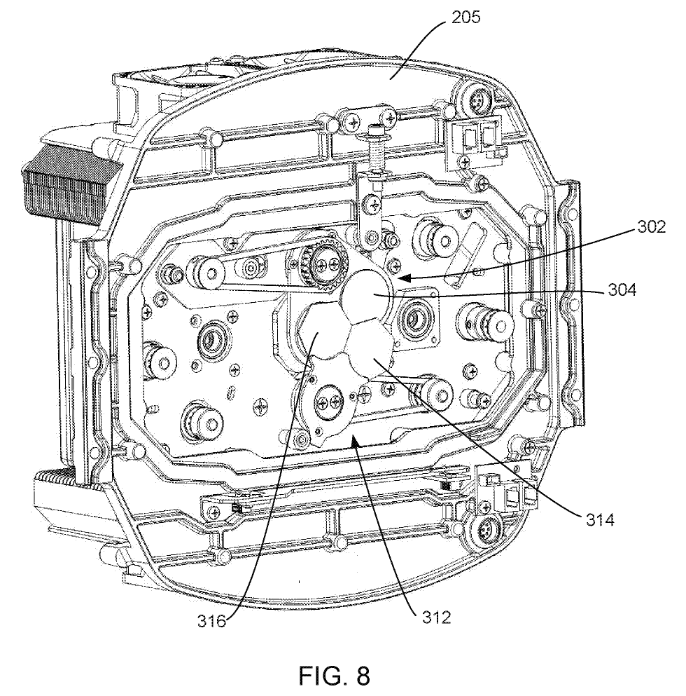

FIG. 8 shows the front face 205 of the light source 202 housing with the interchangeable lens subsystem 302 in the second configuration, in which the second lens (occluded by the second diffuser 316 in FIG. 8) is positioned in the emitted light beam (i.e., from light source 202). In FIG. 8, the interchangeable diffuser subsystem 312 is in the third configuration, in which the second diffuser 316 is positioned in the emitted light beam. That is, when the interchangeable lens subsystem 302 is in the second configuration and the interchangeable diffuser subsystem 312 is in the third configuration, the light beam passes through the second lens 306 and the second diffuser 316.

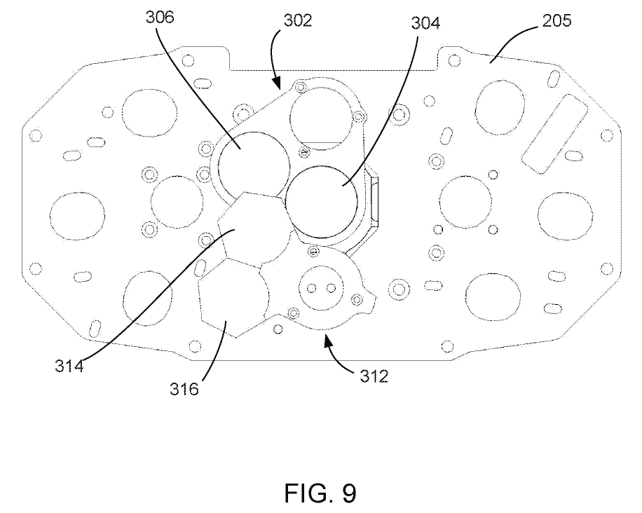

FIG. 9 shows a front view of the front face 205 including the interchangeable lens subsystem 302 and the interchangeable diffuser subsystem 312 in the configurations corresponding to those shown in FIG. 3. That is, in FIG. 9, the first lens 304 is positioned in the emitted light beam (i.e., from light source 202), and neither the first diffuser 314 nor the second diffuser 316 is positioned in the emitted light beam.

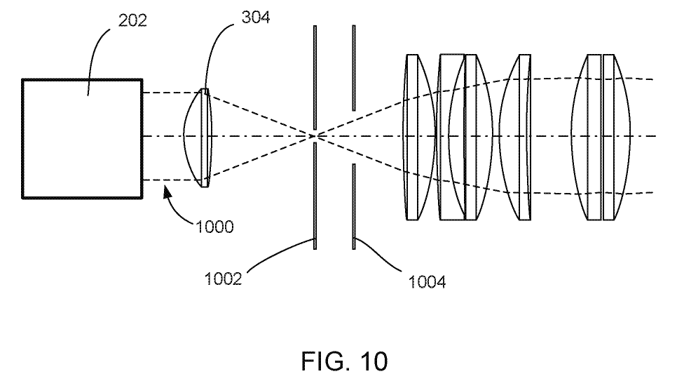

FIG. 10 shows a schematic side view of portions of the internal optical system corresponding to the configuration shown in FIG. 9. That is, in FIG. 10, the first lens 304 is positioned in the emitted light beam 1000 from light source 202, and neither the first diffuser 314 nor the second diffuser 316 is positioned in the emitted light beam 1000. In the example of FIG. 10, the first lens 304 is an aspherical condenser lens 304. As explained above, the aspherical condenser lens 304 may have a relatively short focal length, which produces a relatively small image for higher-intensity output. FIG. 10 also shows a first gobo wheel 1002 and a second gobo wheel 1004. In this example, gobos of the first gobo wheel 1002 have smaller apertures than gobos of the second gobo wheel 1004.

The output provided by the aspherical condenser lens 304 may be more suited for relatively smaller gobo apertures, such as those in the first gobo wheel 1002. The relatively small image produced by the aspherical condenser lens 304 thus avoids excessive light loss (e.g., due to light being blocked by the structure of the gobo wheel 1002 rather than passing through an aperture of the gobo wheel 1002), and thus inefficiency. Accordingly, when positioning the aspherical condenser lens 304 in the emitted light beam 1000, the luminaire 100 may be able to produce narrow aerial beams using relatively smaller-hole gobos (i.e., of the gobo wheel 1002) with a relatively high optical efficiency. Although not depicted in FIG. 10 for simplicity, the first diffuser 314 or the second diffuser 316 may be additionally positioned in the emitted light beam 1000 to provide increased beam flatness and homogeneity.

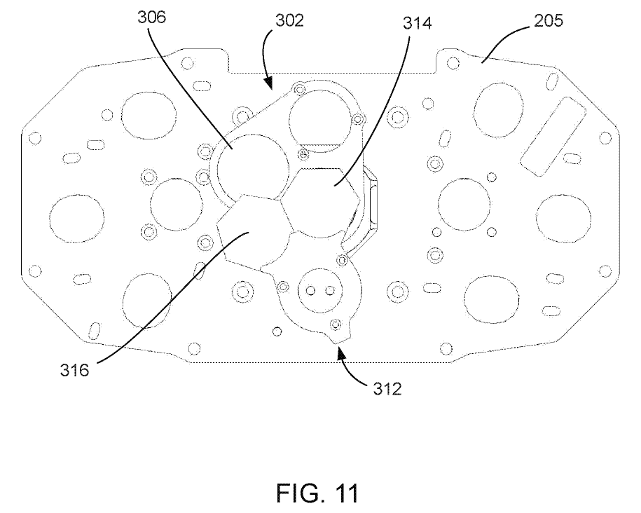

FIG. 11 shows a front view of the front face 205 including the interchangeable lens subsystem 302 and the interchangeable diffuser subsystem 312 in the configurations corresponding to those shown in FIG. 5. That is, in FIG. 11, the first lens (occluded by the first diffuser 314 in FIG. 11) is positioned in the emitted light beam (i.e., from light source 202), and the first diffuser 314 is positioned in the emitted light beam.

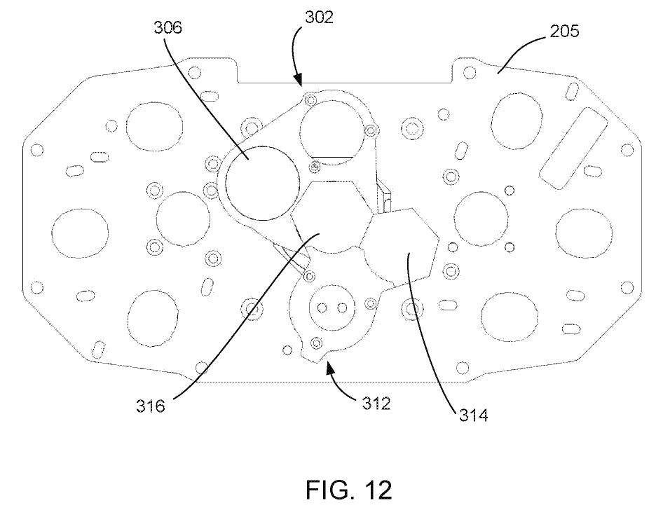

FIG. 12 shows a front view of the front face 205 including the interchangeable lens subsystem 302 and the interchangeable diffuser subsystem 312 in the configurations corresponding to those shown in FIG. 6. That is, in FIG. 12, the first lens (occluded by the second diffuser 316 in FIG. 12) is positioned in the emitted light beam (i.e., from light source 202), and the second diffuser 316 is positioned in the emitted light beam.

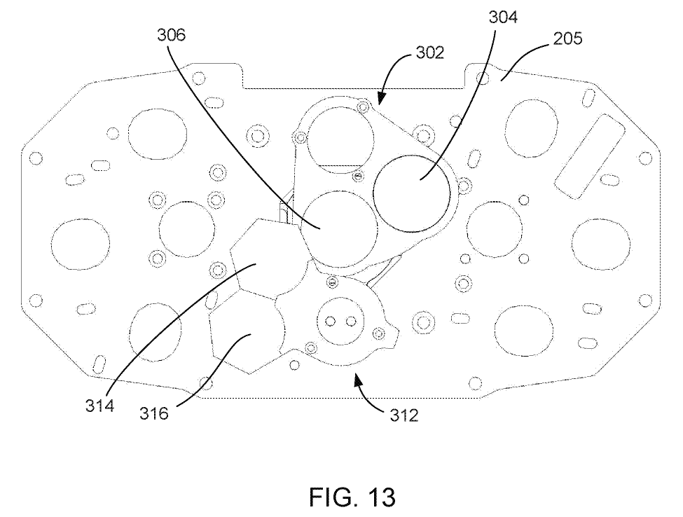

FIG. 13 shows a front view of the front face 205 including the interchangeable lens subsystem 302 and the interchangeable diffuser subsystem 312 in the configurations corresponding to those shown in FIG. 4. That is, in FIG. 13, the second lens 306 is positioned in the emitted light beam (i.e., from light source 202), and neither the first diffuser 314 nor the second diffuser 316 is positioned in the emitted light beam.

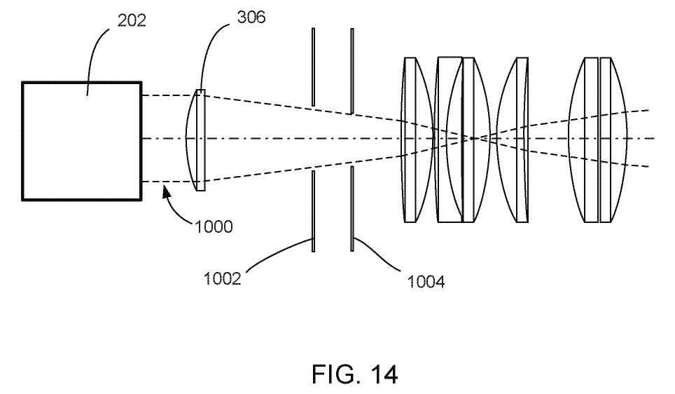

FIG. 14 shows a schematic side view of portions of the internal optical system 200 corresponding to the configuration shown in FIG. 13. That is, in FIG. 14, the second lens 306 is positioned in the emitted light beam 1000 from light source 202, and neither the first diffuser 314 nor the second diffuser 316 is positioned in the emitted light beam 1000. In the example of FIG. 14, the second lens 306 is a spherical condenser lens 306. As explained above, the spherical condenser lens 306 may have a relatively longer focal length, which produces a relatively larger image for wider output. FIG. 14 also shows the first gobo wheel 1002 and the second gobo wheel 1004, described above.

The output provided by the spherical condenser lens 306 may be more suited for relatively larger gobo apertures, such as those in the second gobo wheel 1004. The relatively larger image for wider output produced by the spherical condenser lens 306 thus more fully illuminates larger-aperture gobos such as those in the second gobo wheel 1004. Using the spherical condenser lens 306 with the second gobo wheel 1004 also improves a usable zoom range at wider angles, which might be limited if only smaller-aperture gobos (such as those in the first gobo wheel 1002) were able to be used.

Accordingly, when positioning the spherical condenser lens 306 in the emitted light beam 1000, the luminaire 100 may be able to use relatively larger-hole gobos (i.e., of the gobo wheel 1004) to provide a greater usable zoom range at wider angles. In some cases, using only the spherical condenser lens 306 in the emitted light beam 1000 may still result in a hotspot in the output beam. However, although not depicted in FIG. 14 for simplicity, the first diffuser 314 or the second diffuser 316 may be additionally positioned in the emitted light beam 1000 to provide increased beam flatness and homogeneity, reducing or eliminating the presence of such a hotspot.

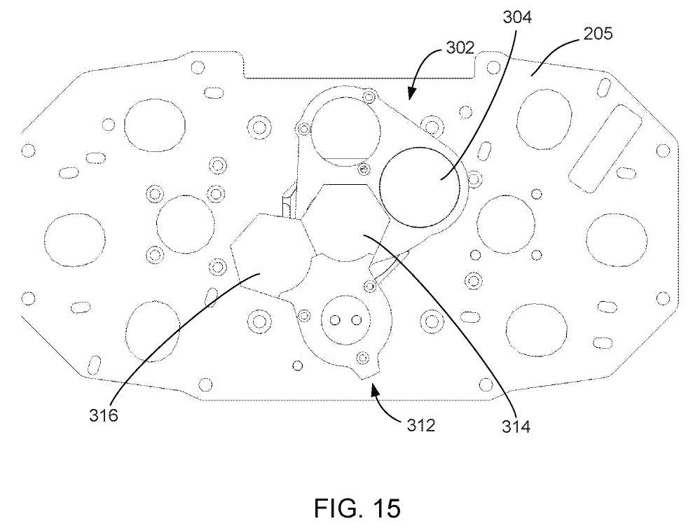

FIG. 15 shows a front view of the front face 205 including the interchangeable lens subsystem 302 and the interchangeable diffuser subsystem 312 in the configurations corresponding to those shown in FIG. 7. That is, in FIG. 15, the second lens (occluded by the first diffuser 314 in FIG. 15) is positioned in the emitted light beam (i.e., from light source 202), and the first diffuser 314 is positioned in the emitted light beam.

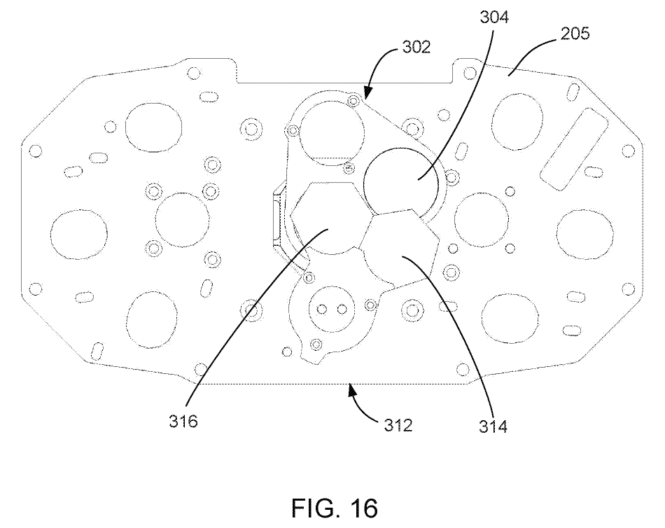

FIG. 16 shows a front view of the front face 205 including the interchangeable lens subsystem 302 and the interchangeable diffuser subsystem 312 in the configurations corresponding to those shown in FIG. 8. That is, in FIG. 16, the second lens (occluded by the second diffuser 316 in FIG. 16) is positioned in the emitted light beam (i.e., from light source 202), and the second diffuser 316 is positioned in the emitted light beam.

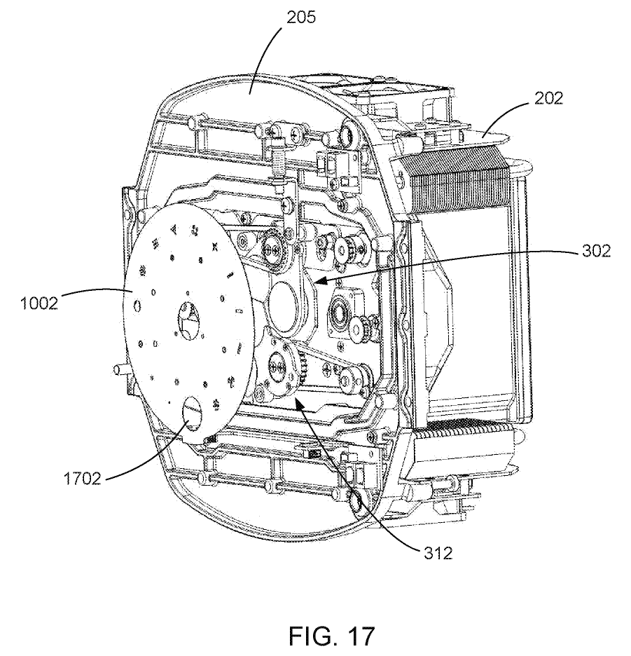

FIG. 17 shows the first gobo wheel 1002 in relation to the interchangeable lens subsystem 302 and the interchangeable diffuser subsystem 312 described above. The first gobo wheel 1002 is positioned after the interchangeable lens subsystem 302 (and the interchangeable diffuser subsystem 312 if present) in the optical path of the luminaire 100. The first gobo wheel 1002 comprises a plurality of gobos and a through hole 1702 (e.g., an open position). The first gobo wheel 1002 is configured to be actuated to move a selected one of the plurality of gobos (or the through hole 1702) into the light beam emitted by light source 202. As explained above, the first gobo wheel 1002 may represent an imaging plane of the luminaire 100. Thus, as shown in FIG. 17, the interchangeable lens subsystem 302 (and the interchangeable diffuser subsystem 312 if present) is positioned after the light source 202, but before the imaging plane of the first gobo wheel 1002 in the optical path of the luminaire 100. Through hole 1702 is sized such that light is not obstructed from the gobos on the second gobo wheel 1004 when either lens 304, 306 is selected on the interchangeable lens subsystem 302.

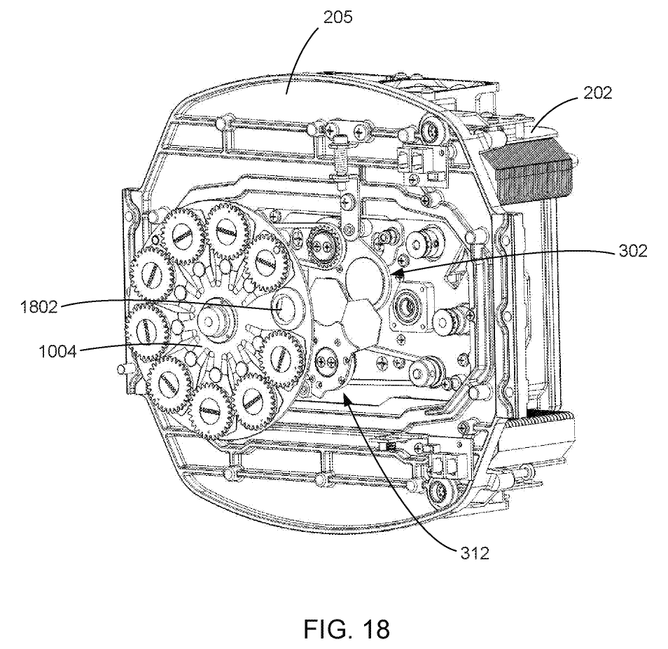

FIG. 18 shows the second gobo wheel 1004 in relation to the interchangeable lens subsystem 302 and the interchangeable diffuser subsystem 312 described above. The second gobo wheel 1004 is positioned after the interchangeable lens subsystem 302 (and the interchangeable diffuser subsystem 312 if present) in the optical path of the luminaire 100. The second gobo wheel 1004 is also positioned after the first gobo wheel 1002 (occluded by second gobo wheel 1004 in FIG. 18) in the optical path of the luminaire 100. The second gobo wheel 1004 comprises a plurality of gobos and a through hole 1802 (e.g., an open position). The second gobo wheel 1004 is configured to be actuated to move a selected one of the plurality of gobos (or the through hole 1802) into the light beam emitted by light source 202. As explained above, the second gobo wheel 1004 may represent an imaging plane of the luminaire 100. Thus, as shown in FIG. 18, the interchangeable lens subsystem 302 (and the interchangeable diffuser subsystem 312 if present) is positioned after the light source 202, but before the imaging plane of the second gobo wheel 1004 in the optical path of the luminaire 100.

In an example, the first gobo wheel 1002 is a small gobo wheel 1002 and the second gobo wheel 1004 is a large gobo wheel 1004. More specifically, an aperture size of each of the gobos of the first gobo wheel 1002 may be smaller than an aperture size of each of the gobos of the second gobo wheel 1004. Although FIGS. 10, 14, 17, and 18 depict the small gobo wheel 1002 as being before the large gobo wheel 1004 in the optical path of the luminaire 100, in other examples, the position of the gobo wheels 1002, 1004 may be reversed. That is, the large gobo wheel 1004 may be before the small gobo wheel 1002 in the optical path of the luminaire 100

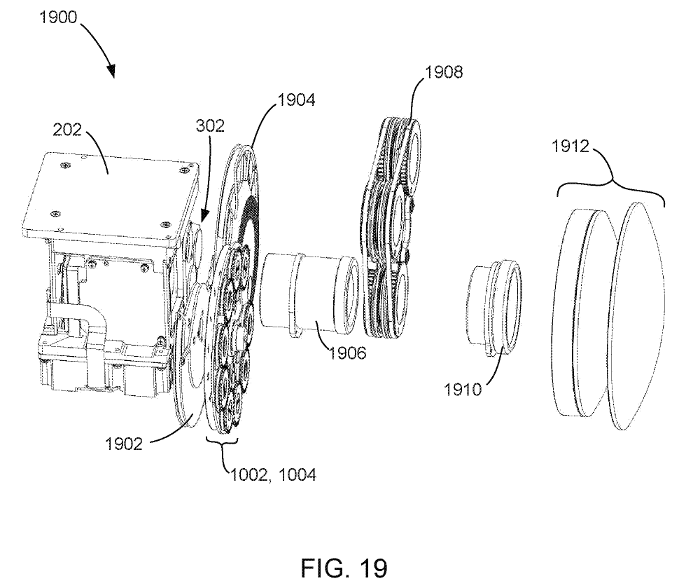

FIG. 19 shows an exploded view 1900 of the internal optical system 200 of the luminaire 100 of FIG. 1, including the interchangeable lens subsystem 302. The exploded view 1900 includes color mixing system 1902 and a color wheel 1904 following the interchangeable lens subsystem 302 in the optical path of the luminaire 100. The first and second gobo wheels 1002, 1004 follow the color wheel 1904 in the optical path of the luminaire 100. The exploded view 1900 also includes various elements of the optical assembly 206, such as a first element 1906 of a zoom subsystem, interchangeable prisms 1908, a second element 1910 of the zoom subsystem, and a final element 1912 of the zoom subsystem.

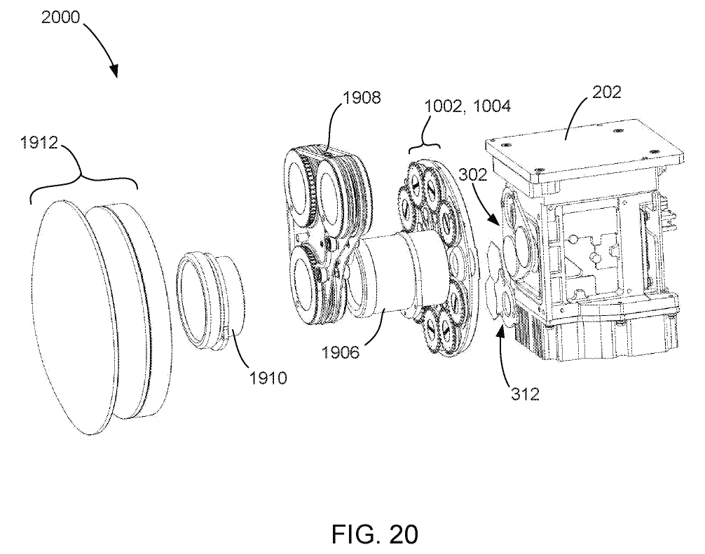

FIG. 20 shows an exploded view 2000 of the internal optical system 200 of the luminaire 100 of FIG. 1, including the interchangeable lens subsystem 302 and the interchangeable diffuser subsystem 312. The exploded view 2000 is generally similar to the exploded view 1900 and like elements are not described again. The exploded view 2000 is from a different angle that enables better visibility to the interchangeable lens subsystem 302 and the interchangeable diffuser subsystem 312 proximate to an exit of the light source 202 from which a light beam is emitted.

As described above, the luminaire 100 may include a control system (or controller) 110. In one example, the control system 110 is configured to receive, via a data link, a command to select one of the gobos of the second gobo wheel 1004 (i.e., a relatively larger gobo). In response to receiving such a command, the control system 110 is configured to control the interchangeable lens subsystem 302 to remain in or move to the second configuration (i.e., to position the second lens 306 in the emitted light beam). Using the first lens 304 (having a relatively shorter focal length) with the relatively larger gobos of the second gobo wheel 1004 could damage those gobos. Accordingly, by automating this control aspect, potential damage to the second gobo wheel 1004 may be avoided.

In another example, the control system 110 is configured to receive, via a data link, a command to select one of the gobos of the first gobo wheel 1002 (i.e., a relatively smaller gobo). In response to receiving such a command, the control system 110 is configured to control the interchangeable lens subsystem 302 to remain in or move to the first configuration (i.e., to position the first lens 304 in the emitted light beam). Using the second lens 306 (having a relatively longer focal length) with the relatively smaller gobos of the first gobo wheel 1002 would result in a relatively low light output, which may be undesirable. Accordingly, by automating this control aspect, an unintended low-output scenario may be avoided.

In the examples described above, the interchangeable lens subsystem 302 and the interchangeable diffuser subsystem 312 are separate, and independently-controllable elements. However, in a different embodiment, various combinations provided by the interchangeable lens subsystem 302 and the interchangeable diffuser subsystem 312 may be integrated into a single interchangeable lens-diffuser subsystem. For example, such an interchangeable lens-diffuser subsystem may comprise a motorized wheel having multiple positions. The motorized wheel is configured to be actuated to move a selected one of the positions into the light beam emitted by light source 202.

Each of the various positions of the interchangeable lens-diffuser subsystem may correspond to one of the above-described combinations of configurations of the interchangeable lens subsystem 302 and the interchangeable diffuser subsystem 312. For example, an aspherical condenser lens (e.g., similar to the first lens 304) may be in a first position of the motorized wheel. A stacked arrangement of an aspherical condenser lens (e.g., similar to the first lens 304) and a first diffuser (e.g., similar to first diffuser 314) may be in a second position of the motorized wheel. A stacked arrangement of an aspherical condenser lens (e.g., similar to the first lens 304) and a second diffuser (e.g., similar to second diffuser 316) may be in a third position of the motorized wheel. The second diffuser in the third position may provide a greater degree of diffusion than the first diffuser in the second position. A stacked arrangement of a spherical condenser lens (e.g., similar to the second lens 306) and a third diffuser (e.g., similar to first diffuser 314) may be in a fourth position of the motorized wheel. A stacked arrangement of a spherical condenser lens (e.g., similar to the second lens 306) and a fourth diffuser (e.g., similar to second diffuser 316) may be in a fifth position of the motorized wheel. The fourth diffuser in the fifth position may provide a greater degree of diffusion than the third diffuser in the fourth position. In a specific example, the third and fourth diffusers may provide degrees of diffusion that are approximately equal to the first and second diffusers, respectively. In another embodiment, the motorized wheel may include a sixth position that contains a spherical condenser lens (e.g., similar to the second lens 306) may be in a first position of the motorized wheel.

In a first configuration of the interchangeable lens-diffuser subsystem the first position of the motorized wheel is positioned in the emitted light beam. In a second configuration of the interchangeable lens-diffuser subsystem, the second position of the motorized wheel is positioned in the emitted light beam. In a third configuration of the interchangeable lens-diffuser subsystem, the third position of the motorized wheel is positioned in the emitted light beam. In a fourth configuration of the interchangeable lens-diffuser subsystem, the fourth position of the motorized wheel is positioned in the emitted light beam. In a fifth configuration of the interchangeable lens-diffuser subsystem, the fifth position of the motorized wheel is positioned in the emitted light beam. In a sixth configuration of the interchangeable lens-diffuser subsystem, the sixth position of the motorized wheel is positioned in the emitted light beam.

As described above, in one example, the control system 110 is configured to receive, via a data link, a command to select one of the gobos of the second gobo wheel 1004 (i.e., a relatively larger gobo). In response to receiving such a command, the control system 110 is configured to control the interchangeable lens-diffuser subsystem to remain in or move to the fourth, fifth, or sixth configurations (i.e., to position the second lens 306 in the emitted light beam). Using the first lens 304 (having a relatively shorter focal length) with the relatively larger gobos of the second gobo wheel 1004 could damage those gobos. Accordingly, by automating this control aspect, potential damage to the second gobo wheel 1004 may be avoided.

Moving or otherwise adjusting various components of the luminaire 100 (including the interchangeable lens subsystem 302, the interchangeable diffuser subsystem 312, or the interchangeable lens-diffuser subsystem, depending on the embodiment) may be provided through mechanical couplings to hand-operated manual controls or to motors, linear actuators, or other electromechanical mechanisms for motion. Such electromechanical mechanisms are electrically coupled to the control system 110. In such embodiments, the control system 110 is configured to move various components of the luminaire 100 in response to signals (e.g., commands) received via a data link of the luminaire 100.

In the examples described above, the luminaire 100 includes the interchangeable lens subsystem 302, and the presence of the interchangeable diffuser subsystem 312 may be considered optional. However, in a different embodiment, the luminaire 100 includes the interchangeable diffuser subsystem 312, and the presence of the interchangeable lens subsystem 302 may be considered optional.

Also, in the examples described above, the interchangeable lens subsystem 302 is generally described as being before the interchangeable diffuser subsystem 312 in the optical path of the luminaire 100. However, in a different embodiment, the positions of the subsystems 302, 312 may be switched. That is, the interchangeable lens subsystem 302 may be after the interchangeable diffuser subsystem 312 in the optical path of the luminaire 100.

In the examples described above, the interchangeable lens subsystem 302 includes multiple lenses that may be alternately positioned in the emitted light beam 1000. However, in a different embodiment, the interchangeable lens subsystem 302 may comprise a fixed lens in the emitted light beam 1000 with an additional lens that is movable to be positioned in or out of the emitted light beam 1000. In another embodiment, the interchangeable lens subsystem 302 may comprise a single, adaptive lens positioned in the emitted light beam 1000 that has a configurable focal length (i.e., implements the variable focal length functionality of interchangeable lens subsystem 302 described above).

In the examples described above, the interchangeable diffuser subsystem 312 includes multiple diffusers that may be alternately positioned in the emitted light beam 1000. However, in a different embodiment, the interchangeable diffuser subsystem 312 may include a progressive diffuser (i.e., a single element that provides varied diffusion, such as a continuously-varied diffuser). The diffuser(s) of the interchangeable diffuser subsystem 312 may be implemented in any suitable manner to provide the diffusion functionality described above. In one example, the diffuser(s) may be single- or double-sided lens arrays. For example, the diffuser(s) may be implemented as a multi-lens array (e.g., a fly-eye integrator lens). Additionally, in yet another embodiment, the interchangeable diffuser subsystem 312 may include only a single diffuser that is either positioned in the emitted light beam 1000 or positioned out of the emitted light beam 1000.

While only some embodiments of the disclosure have been described herein, those skilled in the art, having benefit of this disclosure, will appreciate that other embodiments may be devised which do not depart from the scope of the disclosure. While the disclosure has been described in detail, it should be understood that various changes, substitutions and alterations can be made hereto without departing from the spirit and scope of the disclosure.

What is claimed is:

1. A luminaire, comprising:
a light source configured to generate an emitted light beam; and
an interchangeable lens subsystem positioned after the light source and before an imaging plane in an optical path of the luminaire, the interchangeable lens subsystem comprising:
a first lens having a first focal length; and
a second lens having a second focal length, wherein the second focal length is different than the first focal length,
wherein in a first configuration of the interchangeable lens subsystem, the first lens is positioned in the emitted light beam, and
wherein in a second configuration of the interchangeable lens subsystem, the second lens is positioned in the emitted light beam.

2. The luminaire of claim 1, further comprising an interchangeable diffuser subsystem positioned before the imaging plane in the optical path of the luminaire, the interchangeable diffuser subsystem comprising:
a first diffuser configured to provide a first degree of diffusion to a light beam passing therethrough; and
a second diffuser configured to provide a second degree of diffusion to a light beam passing therethrough, wherein the second degree is greater than the first degree,
wherein in a first configuration of the interchangeable diffuser subsystem, neither the first diffuser nor the second diffuser is positioned in the emitted light beam,
wherein in a second configuration of the interchangeable diffuser subsystem, the first diffuser is positioned in the emitted light beam, and
wherein in a third configuration of the interchangeable diffuser subsystem, the second diffuser is positioned in the emitted light beam.

3. The luminaire of claim 2, wherein the configuration of the interchangeable lens subsystem is controllable independently of the configuration of the interchangeable diffuser subsystem.

4. The luminaire of claim 2, wherein the interchangeable diffuser subsystem comprises a motorized carrier that holds the first diffuser and the second diffuser, wherein rotation of the motorized carrier causes the interchangeable diffuser subsystem to change between the first, second, and third configurations.

5. The luminaire of claim 4, wherein the first and second diffusers are hexagonal in shape, and wherein a side of the first diffuser abuts a side of the second diffuser.

6. The luminaire of claim 1, wherein the interchangeable lens subsystem comprises a motorized carrier that holds the first lens and the second lens, wherein rotation of the motorized carrier causes the interchangeable lens subsystem to change between the first and second configurations.

7. The luminaire of claim 1, further comprising:
a first gobo wheel comprising a first plurality of gobos and an open position, and wherein the first gobo wheel is configured to be actuated to move a selected one of the first plurality of gobos into the emitted light beam; and
a second gobo wheel comprising a second plurality of gobos, and wherein the second gobo wheel is configured to be actuated to move a selected one of the second plurality of gobos into the emitted light beam,
wherein the first and second gobo wheels are positioned after the interchangeable lens subsystem in the optical path of the luminaire, and
wherein an aperture size of each of the first plurality of gobos is smaller than an aperture size of each of the second plurality of gobos.

8. The luminaire of claim 7, wherein the first lens is an aspherical condenser lens, and wherein the second lens is a spherical condenser lens.

9. The luminaire of claim 8, further comprising a control system configured to:
receive, via a data link, a first command selecting one of the second plurality of gobos; and
control the interchangeable lens subsystem to remain in or move to the second configuration responsive to the first command.

10. The luminaire of claim 8, further comprising a control system configured to:
receive, via a data link, a second command selecting one of the first plurality of gobos; and
control the interchangeable lens subsystem to remain in or move to the first configuration responsive to the second command.

11. A luminaire, comprising:
a light source configured to generate an emitted light beam; and
an interchangeable lens-diffuser subsystem positioned after the light source and before an imaging plane in an optical path of the luminaire, the interchangeable lens-diffuser subsystem comprising:
a motorized wheel;
an aspherical condenser lens in a first position of the motorized wheel;
a stacked arrangement of an aspherical condenser lens and a first diffuser in a second position of the motorized wheel, wherein the first diffuser is configured to provide a first degree of diffusion to a light beam passing therethrough;
a stacked arrangement of an aspherical condenser lens and a second diffuser in a third position of the motorized wheel, wherein the second diffuser is configured to provide a second degree of diffusion to a light beam passing therethrough, and wherein the second degree is greater than the first degree;
a stacked arrangement of a spherical condenser lens and a third diffuser in a fourth position of the motorized wheel, wherein the third diffuser is configured to provide a third degree of diffusion to a light beam passing therethrough; and
a stacked arrangement of a spherical condenser lens and a fourth diffuser in a fifth position of the motorized wheel, wherein the fourth diffuser is configured to provide a fourth degree of diffusion to a light beam passing therethrough, and wherein the fourth degree is greater than the third degree.

12. The luminaire of claim 11, wherein the third degree is approximately equal to the first degree, and wherein the fourth degree is approximately equal to the second degree.

13. The luminaire of claim 11, wherein the interchangeable lens-diffuser subsystem further comprises a spherical condenser lens in a sixth position of the motorized wheel.

14. The luminaire of claim 11, wherein in a first configuration of the interchangeable lens-diffuser subsystem, the first position of the motorized wheel is positioned in the emitted light beam,
wherein in a second configuration of the interchangeable lens-diffuser subsystem, the second position of the motorized wheel is positioned in the emitted light beam,
wherein in a third configuration of the interchangeable lens-diffuser subsystem, the third position of the motorized wheel is positioned in the emitted light beam,
wherein in a fourth configuration of the interchangeable lens-diffuser subsystem, the fourth position of the motorized wheel is positioned in the emitted light beam, and
wherein in a fifth configuration of the interchangeable lens-diffuser subsystem, the fifth position of the motorized wheel is positioned in the emitted light beam.

15. The luminaire of claim 14, further comprising:
a first gobo wheel comprising a first plurality of gobos, wherein the first gobo wheel is configured to be actuated to move a selected one of the first plurality of gobos into the emitted light beam; and
a second gobo wheel comprising a second plurality of gobos, wherein the second gobo wheel is configured to be actuated to move a selected one of the second plurality of gobos into the emitted light beam,
wherein the first and second gobo wheels are positioned after the interchangeable lens subsystem in the optical path of the luminaire, and
wherein an aperture size of each of the first plurality of gobos is smaller than an aperture size of each of the second plurality of gobos.

16. The luminaire of claim 15, further comprising a control system configured to:
receive, via a data link, a first command selecting one of the second plurality of gobos; and
control the interchangeable lens-diffuser subsystem to remain in or move to the fourth configuration or the fifth configuration responsive to the first command.
